(19) United States
(12) Patent Application Publication
(10) Pub. No.: US 2022/0413615 A1
(43) Pub. Date: Dec. 29, 2022

(54) METHOD FOR GENERATING TACTILE SENSATIONS LOCATED ON A SURFACE AND HAPTIC INTERFACE IMPLEMENTING THIS METHOD

(71) Applicant: ACTRONIKA, PARIS (FR)

(72) Inventors: Damien FAUX, PARIS (FR); Vincent HAYWARD, PARIS (FR); Michael WIERTLEWSKI, GV Delft (NL)

(21) Appl. No.: 17/784,397

(22) PCT Filed: Dec. 10, 2020
(86) PCT No.: PCT/EP2020/085433

§ 371 Date: Jun. 10, 2022

(30) Foreign Application Priority Data
Dec. 12, 2019 (FR) FR1914269

(51) Int. Cl. G06F 3/01; G06F 3/041

(52) U.S. Cl. CPC G06F 3/016; G06F 3/0416

(57) ABSTRACT

A method for generating a tactile sensation to be sensed by a user in contact, in two separate regions, with a contact surface of a haptic interface, includes simultaneously emitting a first control signal for controlling a first actuator and a second control signal for controlling a second actuator at the same time as the first actuator, the first and second actuators being joined to the contact surface and bringing about movements of the contact surface, wherein the first and second actuators determine a superimposition of movements of the contact surface such that the movements of the two designated regions of the same contact surface follow predetermined trajectories that are independent of one another.

### TECHNICAL FIELD OF THE INVENTION

The present invention relates to a method for generating tactile sensations intended to be sensed by the user of a haptic interface comprising a surface. The invention also relates to such a haptic interface implementing this method. The invention has applications in the fields of haptics for procuring tactile sensations to users of haptic interfaces and, in particular, in the fields where a haptic interface can be shared between several users or shared between several fingers of a single or of several hands such as for example the interfaces of motor vehicles, collaborative interfaces, portable wireless communication devices, or portable computers and derived devices such as touch tablets.

### TECHNOLOGICAL BACKGROUND OF THE INVENTION

It is known, in the haptic field, to seek to produce or to reproduce, by means of a machine, the sensations of touch sensed by a person.

It is known, in particular, to procure tactile sensations to the user of a haptic interface-also called tactile interface-to simulate, in particular, the triggering of a key, the manipulation of a thumbwheel, the sensing of a texture or of discrete elements when the user is in mechanical contact with the haptic interface, for example when the user exerts a press on the contact surface of the haptic interface or moves their finger on this surface. There exists, in the state of the art, several systems that make it possible to generate these tactile sensations. These systems often comprise one or more actuators fixed on a touchscreen or on the surface made of glass, metal, polymer, or even wood, in such a way as to move the touchscreen by small quick movements, generated in response to a motor action of the user. These systems, when they sufficiently faithfully reproduce the natural mechanical signals, allow the user to sense realistic tactile sensations. A well-known example is when the user presses the contact surface of the touchscreen and the latter responds to the press via a brief movement, then this user has the sensation of actuating a button. If the user slides the finger over the contact surface and the touchscreen responds with certain quick oscillations, then the user has the sensation of touching a texture.

However, although these systems make it possible to produce a tactile sensation when a finger of the user comes into contact with the contact surface of the haptic interface, the haptic sensation is no longer clearly sensed when the user has several fingers in contact with the same contact surface or if several users are in contact with the same contact surface.

However, certain haptic interfaces are intended to be used with several fingers of a single person and of several persons who share the use thereof, such as for example motor vehicle interfaces, screens for sharing documents, or front faces of control panels for industrial devices, medical devices, household devices, cash registers, public ticket distributors, cash withdrawal, or for taking order in restaurants, casino machines, devices for viewing, listening to audio documents or mixing audio tracks, personal computers, portable mobile telephones, electronic readers, computer tablets, or any other sort of so-called connected devices.

To respond to this need, manufacturers of haptic interfaces and researches have proposed different methods that can be categorised into four classes.

Those of the first class use a separate source of mechanical energy for each region of the stimulating surface. In this class, patent U.S. Pat. No. 7,148,789 describes a portable telephone device where several electromagnetic actuators are assigned to the fingers of a hand holding the device. Patent application WO 2009/085060 describes a surface provided with several actuators that can be activated independently from one another. Patent application U.S. Pat. No. 20,100,156 818 A1 describes a tactile interaction surface deformed by several piezoelectric actuators that are supposed to act only in their vicinity so as to procure separate sensations to several fingers. Patent U.S. Pat. No. 7,973,769 describes a surface intended to produce tactile sensations confined to regions isolated from the rest of the surface by an elastic material and where each region can be excited by a separate actuator. Patent U.S. Pat. No. 8,339,250 also describes a portable telephone apparatus the front face of which comprises flexible elements excited by individual means of actuation. Patent U.S. Pat. No. 8,390,594 describes a surface comprised of several layers intended to be in contact with fingers. An intermediate layer is made from a matrix of elastomer material wherein a board of piezoelectric actuators is included that can act on the external layer. Patent U.S. Pat. No. 9,164,586 describes a similar arrangement with the difference that the actuators make use of electroactive polymers based on the principle of electrostriction. Patent U.S. Pat. No. 9,448,628 describes an alphanumerical keyboard where each key is associated with an unspecified actuator, configured to deform an external elastic layer. Patent U.S. Pat. No. 9,600,071 describes a similar tactile surface with the difference that the actuators are of the electrodynamic type. Patent application U.S. Pat. No. 20,180,081 438 describes an arrangement similar to the preceding descriptions but that differs by the mode of transmission of the force of the actuators to the external surface. Patent application U.S. Pat. No. 20,180,081 44 also describes a similar arrangement where explicit mention is made of a flexible external layer.

To overcome the limitations of the haptic interfaces designed for procuring specific tactile sensations at regions that are confined due to the propagation of mechanical excitations in the structures, the methods mentioned hereinabove often make use of means of mechanical isolation from one region to another. These means in turn have the disadvantage of making the manufacture of such interfaces more complex. To overcome this latter disadvantage, a second class of methods uses a plurality of actuators distributed over a surface where each actuator preferably excites one of the regions of the surface while the other actuators are used to dampen or cancel the movements of the regions where these movements are not desired. Patent U.S. Pat. No. 8,378,797 describes a haptic interface based on this method by application, in each region where the oscillations have to be attenuated, oscillations that phase of which is opposite the undesired oscillation. However this patent remains silent on the fact that the attenuating oscillations also influence the other regions of the surface. Patent U.S. Pat. No. 8,593,409 is based on a method similar to the preceding with the difference that mention is made of the propagation phenomenon of waves coming from resonant actuators with a high quality coefficient Q in a flexible surface. It stems from this that such a method is, by construction, strictly limited in time resolution and has no resolution in the frequency domain. Patent U.S. Pat. No. 8,686,952 describes a similar method but remains silent as to the way in which the signals coming from different actuators are combined according to the laws of wave mechanics. Patent U.S. Pat. No. 8,890,668 describes a method similar to the one of patent U.S. Pat. No. 8,378,797 to which it provides minor clarifications. Patents FR 3 076 017 and WO 2019 122 762 describe a method for a haptic interface or a plurality of actuators regularly distributed over the entire surface and where the transfer function in the frequency domain is obtained between each actuator and each region of the interface. This transfer function is inversed according to a method known in the field of signal processing and of control of methods with multiple inputs and multiple outputs. This problem has been studied for more than a century (for example: Poincaré, H. 1907. Etude du récepteur téléphonique, Eclairage Electrique, vol. 50, pp. 221-372). These theoretical considerations reveal that such a transfer function is not always inversible (Kavanagh, R. J. 1956. The application of matrix methods to multi-variable control systems. Journal of the Franklin Institute, 262(5), 349-367), which limits the applications of such a method.

To respond to the limitations of the methods mentioned hereinabove, a third class of methods for generating tactile sensations located at a region of a surface proposes to take account of the behaviour of waves in the thin plates to cause differentiated oscillations in several regions of a surface. Patent application U.S. Pat. No. 2,015,013 8157 proposes to excite primary modes of the plate so as to have it oscillate differently in wide regions. To do this, the method uses two sets of actuators controlled separately. The first set is intended to excite certain oscillation modes of the plate to have it vibrate in a certain zone. The second set is intended to vibrate the plate in another zone, in part to attenuate the undesired vibrations but especially for transforming the plate into an acoustic radiator. Patent U.S. Pat. No. 9,449,476 describes a method that is based on the propagation of bending waves in a thin plate and where the actuators are separated from the zone to be excited. This method is furthermore based on the detection of ultrasonic oscillations so as to measure the variations thereof due to the disturbances of a finger in contact in order to determine the region in question.

A fourth class of methods uses various electrical and mechanical artifacts to cause a tactile stimulation in a region without provoking sensations in the others. Patent application U.S. Pat. No. 2,008,006 8334 describes a method according to which the surface intended to stimulate a finger is comprised of regions having different stiffnesses in such a way that the stimulation is more intense where the surface is more flexible. Patent application U.S. Pat. No. 2,008,010 0568, similarly, proposes to design the mechanical properties of a shell in such a way as to cause artificial localised tactile sensations in certain regions. Patent application WO 2018 178 582 describes a method comprising a plurality of actuators capable of causing the presence of non-radiative ultrasonic waves in a thin plate intended to carry out a local acoustic lubrication of the surface in the vicinity of each actuator. Patent U.S. Pat. No. 8,174,372 describes a haptic interface where the stimulating surface is an elastic membrane. When a finger presses on this membrane, the latter is deformed to come into contact with a rigid counter-surface indicating on the one hand the presence of a finger and making possible on the other hand the transmission of mechanical oscillations to this finger. Patent US 1 028 9199 describes a method where actuators acting as all-or-nothing are controlled to block the movements of the stimulating surface at the locations where a stimulation is not desired. Patent EP 2 742 410 describes a haptic surface intended to cause artificial tactile sensations by using the principle of cutaneous adhesion by alternating electrostatic field (E. Mallinckrodt, A. L. Hughes, and W. Sleator. 1953. Perception by the skin of electrically induced vibrations, Science, vol. 118, no. 3062, pp. 277-278). In this method, discrete electrodes distributed over the entire surface and activated separately make it possible to cause localised sensations according to a principle similar to the one described in the publication H. Tang and D. Beebe. 1998. A microfabricated electrostatic haptic display for persons with visual impairments. IEEE Transactions on rehabilitation engineering, 6(3):241-248.

The scientific literature also comprises studies of which the purpose is to optimise the local nature of the oscillations caused in a thin plate from a plurality of exciters. The article of J. H. Woo, & J. G. Ih. 2015. Vibration rendering on a thin plate with actuator array at the periphery. Journal of Sound and Vibration, 349, 150-162 describes how oscillations located in a glass plate embedded on its periphery can be created using a large number of actuators acting near the edge. These many actuators, excited at a single frequency of 300 Hz, can excite a large number of modes of which the weighted superimposition makes it possible to create a specific oscillation zone immediately above the human detection threshold of the oscillations. The study of E. Enferad, et. al. 2019, Generating controlled localized stimulations on haptic displays by modal superimposition, Journal of Sound and Vibration, 449. 196-213 demonstrates that it is possible to cause localised oscillations in an aluminium beam at fixed ultrasonic frequencies.

Another technique, based on the exploitation of vibration phenomena and described for example in patent application U.S. Pat. No. 9,436,284, consists of using the principle of time reversal to refocus the waves coming from the pulse responses measured at different points of a thin plate. A study published recently of A. B. Dhiab & C. Hudin/2019. Confinement of Vibrotactile Stimuli in Narrow Plates, in IEEE World Haptics Conference, pp. 431-436 proposes to take advantage of the evanescent waves to confine the oscillations of a thin plate in a small region. Another study, also recent, L. Pantera, & C. Hudin. 2019. Sparse Actuator Array Combined with Inverse Filter for Multitouch Vibrotactile Stimulation, in IEEE World Haptics Conference, pp. 19-24 implements the transfer function inversion method in the frequency domain to create brief oscillations of a micrometre in amplitude in a glass plate by taking advantage of the presence of actuators distributed over the entire surface of the plate.

The techniques of the four classes discussed hereinabove exploiting mechanical artifacts or vibration phenomena have many disadvantages such as, for example: low permissible amplitudes of vibrations due to bending waves propagating via deformation of the touchscreen, the sensitivity to the conditions at the limits and in particular to the embedding conditions of the edges of the screen, the sensitivity to the environmental conditions and in particular to the temperature of the touchscreen, the necessity of using a large number of actuators distributed over the surface and to control them with great time and frequency precision in order to control the interference conditions, and lack of energy efficiency inherent to acoustic excitations.

To respond to the different problems exposed hereinabove, and in particular to the problems of implementing vibration phenomena and to the problems of complexity in controlling a large number of actuators, the applicant has proposed, in a patent application FR1900554, a haptic interface requiring a limited number of actuators, controlled in such a way as to generate movements at any point of the touchscreen except at a neutral point, or a set of superimposed neutral points. The haptic interface implements a computer program that makes it possible to calculate the instantaneous forces that pivot a rigid portion of the interface around the neutral point, or around a set of superimposed neutral points and which gives a desired acceleration to another point or set of points of the rigid portion. The application of the principle of linear superimposition applicable to the small movements of solid bodies makes it possible in particular to produce at the same time a sensation in a single finger and another sensation in another finger, whether they are transient or persistent.

### SUMMARY OF THE INVENTION

The present invention proposes an alternative to the method disclosed in patent application FR1900554, wherein small movements changing over the course of time are generated in at least two regions separated by a contact surface. The method of the present invention is based on the principle of linear superimposition applicable to all the small movements of solid bodies. It makes it possible to determine actuating signals that can be applied to a limited number of actuators capable of causing small movements of solid bodies, including those that correspond to the bending modes of the plates as well as those that correspond to the modes resulting from the establishing of stationary waves.

According to a first aspect, the invention relates to a method for generating a tactile sensation intended to be sensed by a user in contact with a contact surface of a haptic interface, comprising an operation of simultaneously emitting a first control signal for controlling a first actuator and a second control signal for controlling a second actuator, at the same time as the first actuator, the first and second actuators being joined to the contact surface and bringing about movements of said contact surface, characterised in that:
the first control signal comprises a first time change providing to a first region of the contact surface a first time change, and providing a second time change to a second region of the contact surface,
the second control signal comprises a second time change providing to the first region of the contact surface a second time change, and providing a second time change to the second region of the contact surface, and
where the first control signal and the second control signal are such that the time change of the first region of the contact surface is described by a desired function of the time separate from another desired function of the time describing the time change of the second region of the contact surface.

This method makes it possible to generate separate tactile sensations, at the same time, at several locations of the portion of a touchscreen.

Advantageously, the method comprises one or more additional actuators comprising an operation of simultaneously emitting one or more additional control signals for controlling one or more additional actuators at the same time as the first actuator and second actuator, the additional actuators being joined to the contact surface and bringing about movements of said contact surface, and the additional control signals each comprise additional time changes providing to a first region of the contact surface and to a second first region of the contact surface additional time changes.

In addition to the characteristics that have just been mentioned in the preceding paragraph, the method according to an aspect of the invention can have one or more additional characteristics among the following, taken individually or according to any technically permissible combination:
it comprises one or more additional contact regions receiving additional time changes coming from additional actuators and characterised in that the total number of actuators is greater than or equal to the total number of regions.
it comprises a weighted combination of a first dynamic distortion, generated by the first actuator under the effect of the first control signal, and of a second dynamic distortion generated by the second actuator under the effect of the second control signal.
it comprises a weighted combination of a first dynamic distortion, generated by the first actuator under the effect of the first control signal, of a second dynamic distortion generated by the second actuator under the effect of the second control signal, and of one or more additional dynamic distortions generated by one or more additional actuators under the effect of one or more additional control signals.
when the first region and the second region are known in advance the first control signals and the second control signals are determined by means of the following operations:
   a) identifying, for each one of the actuators and each one of the regions of the contact surface, a frequency spectrum representing the weighting according to the frequency of the effect of the actuator over any region of the contact surface;
   b) calculating the inverse matrix H⁻¹₂₂ of the matrix of the spectra H₂₂ associating the first region and the second region, with the first actuator and with the second actuator;
   c) multiplying the inverse matrix H⁻¹₂₂ by the matrix U₂₁ obtained by stacking the frequency spectra U₁ and U₂ coming from the transformation from the time domain to the frequency domain of the desired movements, (u1 and u2) of the contact surface in the regions (Z1 and Z2);
   d) transforming in the time domain of the products obtained in the step c);
   e) applying to the actuators.
when the first region and the second region are known in advance, the first control signals, the second control signals and the possible additional signals are determined by means of the following operations:
   f) identifying, for each one of the actuators and each one of the regions of the contact surface, a frequency spectrum representing the weighting according to the frequency of the effect of the actuator over any region of the contact surface;
   g) extracting lines corresponding to the regions α and β coming from the matrix of the spectra Hᵢⱼ associating each region (i) with each actuator (j) and stacking said lines corresponding to the regions α and β in a single matrix H_{(αβ)j};
   h) calculating the pseudo inverse matrix H⁺H_{(αβ)j} of H_{(αβ)j};
   i) multiplying the pseudo inverse matrix H⁺H_{(αβ)j} by the matrix U_{(αβ)1} obtained by stacking the frequency spectra U_{α} and U_{β} coming from the transformation from the time domain to the frequency domain of the desired movements, u_{α} and u_{β}, of the contact surface in the regions α and β
   j) transforming in the time domain of the products obtained in the step i);
   k) applying to the actuators.
when the first region, the second region and the possible additional regions are known in advance, the first control signals, the second control signals and the possible additional signals are determined by means of the following operations:
   I) identifying, for each one of the actuators and each one of the regions of the contact surface, a frequency spectrum representing the weighting according to the frequency of the effect of the actuator over any region of the contact surface;
   m) extracting lines corresponding to regions α and β and additional regions issue of the matrix of the spectra Hᵢⱼ associating each region (i) with each actuator (j) and stacking said lines corresponding to the regions α and β and to the additional regions into a single matrix H_{cj};
   n) calculating the pseudo inverse matrix H⁺_{jc} of H_{cj};
   o) multiplying the pseudo inverse matrix H⁺_{jc} by the matrix U_{c1} obtained by stacking the frequency spectra coming from the transformation of the desired movements, u_{α} and U_{β}, of the contact surface in the regions α and β and of the additional desired movements.
   p) transforming in the time domain of the products obtained in the step 0);
   q) applying to the actuators.
when the first or the second region vary over the course of time, the first control signals, the second control signals are determined by means of the following operations:
   r) identifying, for each one of the actuators and each one of the regions of the contact surface, a frequency spectrum representing the weighting according to the frequency of the effect of the actuator over any region of the contact surface;
   s) calculating the inverse matrix H⁻¹₂₂ of the matrix of the spectra Hz2 associating the first region and the second region, with the first actuator and with the second actuator;
   t) transforming in the time domain of the products obtained in the step s);
   u) matrix convolving of the product of the step t) by the stack of the desired movements.
   v) applying to the actuators.
when the first region or the second region vary over the course of time, the first control signals, the second control signals and the possible additional control signals are determined by means of the following operations:
   w) identifying, for each one of the actuators and each one of the regions of the contact surface, a frequency spectrum representing the weighting according to the frequency of the effect of the actuator over any region of the contact surface;
   x) extracting of the lines corresponding to the regions α and β coming from the matrix of the spectra Hᵢⱼ associating each region (i) with each actuator (j) and stacking said lines corresponding to the regions α and β in a single matrix H_{(αβ)j};
   y) calculating the pseudo inverse matrix H_{j(αβ)} of H_{(αβ)j};
   z) transforming in the time domain of the products obtained in the step y);
   aa) matrix convolving of the product of the step z) by the stack of the desired movements;
   bb) applying to the actuators.
when the first region or the second region, or the possible additional regions vary over the course of time, the first control signals, the second control signals and the possible additional control signals are determined by means of the following operations:
   cc) identifying, for each one of the actuators and each one of the regions of the contact surface, a frequency spectrum representing the weighting according to the frequency of the effect of the actuator over any region of the contact surface;
   dd) extracting lines corresponding to regions α and β and additional regions issue of the matrix of the spectra Hᵢⱼ associating each region (i) with each actuator (j) and stacking said lines corresponding to the regions α and β and to the additional regions into a single matrix H_{cj};
   ee) calculating the pseudo inverse matrix H⁺_{jc} of H_{cj};
   ff) transforming in the time domain of the products obtained in the step ee);
   gg) matrix convolving of the product of the step ff) by the stack of the desired movements;
   hh) applying to the actuators.

A second aspect of the invention relates to a haptic interface implementing the method hereinabove, characterised in that it comprises:
a contact surface (110) provided with a device for detecting and locating at least one contact point between at least one user (101) and said contact surface;
at least two actuators (120) being joined to the rigid portion, mounted at a distance from one another and adapted to be actuated at the same time so as to generate at least one movement (D) of said rigid portion; and
a processing unit (130) adapted to control each actuator (120) with a different time change.

Advantageously, the haptic interface comprises a frame wherein the contact surface is mounted.

Advantageously, the contact surface is connected to the frame via means of visco-elastic suspension.

According to certain embodiments, the contact surface is rigidly embedded over its entire periphery on a frame.

According to certain embodiments, the contact surface is partially embedded on a frame.

According to certain embodiments, the contact surface is in a free edge embedding condition.

A third aspect of the invention relates to an interactive electronic device, characterised in that it comprises a haptic interface such as defined hereinabove.

### BRIEF DESCRIPTION OF THE FIGURES

Other advantages and characteristics of the invention shall appear when reading the following description, illustrated by the figures wherein:

FIG. 1 diagrammatically shows a view of a haptic interface according to the invention with a user in contact by two fingers with said interface.

FIG. 2 shows a front view of the contact surface where a possible disposition of actuators is mounted on the periphery as well as zones of interest and a processing unit.

FIG. 3 shows a diagrammatical top view of a haptic interface according to an embodiment of the invention, wherein four actuators act in the angles of the contact surface and bear against the frame, the normal direction being conventionally directed according to the direction Z.

FIG. 4 shows a diagrammatical view of a haptic interface according to an embodiment of the invention where two actuators act in the normal direction to the contact surface and two actuators exert bending forces on the plate.

FIG. 5 shows an embodiment where four actuators exert bending forces on the plate in varied directions.

FIG. 6 shows an embodiment where four actuators exert bending forces on the plate and are positioned near the edges of the surface, between two angles.

FIG. 7 shows an embodiment wherein where four actuators exert a thrust in the normal direction causing a rigid movement of the contact surface if the movement is with low acceleration and causing, during a strong acceleration, a main bending mode where the plate temporarily adopts a rounded or a hollow shape.

FIG. 8 shows an embodiment wherein where four actuators exert thrusts in the normal direction able to cause a movement pivoting about an axis of the contact surface in such a way that a finger in contact with this surface on a line will receive no tactile signal while a finger in separated contact from this line will receive a signal.

FIG. 9 shows an embodiment wherein the four actuators exert thrusts in the normal direction able to cause a bending of the contact surface under the effect of forces.

FIG. 10 shows an embodiment wherein the four actuators exert static or dynamic bending forces in the contact surface causing a static or dynamic distortion of this surface.

FIG. 11 shows, for the purposes of exemplification, the dynamic distortion of a contact surface under the effect of a single actuator excited by a short pulse and located in one of its angles that can be compared to the effect of another actuator excited by the same pulse but located in another angle.

FIG. 12 shows, also for the purposes of exemplification, the spectra of the influence of four actuators located at the four angles of a contact surface on the same point.

FIG. 13 shows the steps of a method for determining excitation signals of four actuators in order to produce desired separate movements at the same time in two different regions when these regions are known in advance.

FIG. 14 shows the steps of a method for determining excitation signals of four actuators in order to produce desired separate movements at the same time in two different regions when these regions vary over the course of time.

FIG. 15 shows, at the end of the steps of FIG. 13 or 14, how a weighted combination over the course of time of dynamic distortions caused by the four actuators excited by specific waveforms can reconstruct at a desired point, α, a desired waveform, here a Ricker wavelet, while at the same time, another desired point, β, remains immobile. Other points of the surface are free to move without affecting the tactile operation of the haptic interface.

### DETAILED DESCRIPTION

An example of a haptic interface, wherein small desired movements changing over the course of time are generated in two regions separated by a contact surface, is described in detail hereinafter, in reference to the accompanying drawings. This example shows the characteristics and advantages of the invention. It is however reminded that the invention is not limited to this example.

In the figures, identical elements are marked with identical references. In order to improve the legibility of the figures, the scales of size between elements shown are not respected.

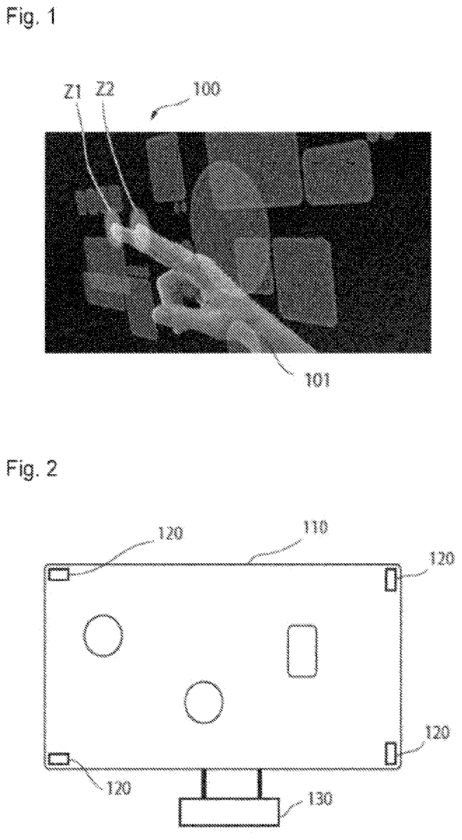

FIGS. 1 and 2 show examples of a haptic interface according to the invention. This haptic interface 100 comprises:
a contact surface 110 through which the user 101 can interact with the haptic interface 100,
actuators 120 that make it possible to generate small movements of the contact surface 110, and
a processing unit 130 that makes it possible, in particular, to control the actuators 120.

An embodiment of a method for generating tactile sensations located on a surface and a haptic interface implementing this method is described in detail hereinafter, in reference to the accompanying drawings. This example shows the characteristics and advantages of the invention. It is however reminded that the invention is not limited to this example.

The contact surface 110 is the face through which the user enters into contact with the haptic interface. This can be the face of a flexible thin plate, for example made in a transparent material, of rectangular shape, as shown in FIG. 2. Those skilled in the art will understand that the contact surface can have shapes other than rectangular, such as for example circular, triangular or trapezoidal. The contact surface can also have shapes other than that of a flexible thin plate. It can be, for example, a shell with the shape of a ruled surface. It can also be a part of arbitrary shape, such as having distorted surfaces. These arbitrary shapes will thus allow for bendings and movements of the shell under the effect of the action of actuators.

The contact surface 110 further comprises a device for detecting and for locating the contact- or the proximity-of the user and determining the coordinates and can furthermore estimate the size of the contact zone. The contact surface can also comprise a device for measuring the force applied by the user. Such devices for detecting, locating the contact and measuring the force are well known in the field of tactile surfaces and therefore shall not be described in any further detail.

In the rest of the description, the invention shall be described for a number of four actuators and for two separate zones or regions. It is of course understood that the method can be applied to a number of actuators different from four, for example two, three, five, six, seven or eight, while still remaining a low number with respect to the prior arts described hereinabove. Likewise, the method can be applied to a number of regions (or zones) different from two, for example three, four, etc.

In the example of FIG. 1, two fingers of the user 101 are in contact, at the same time, with two separate zones Z1 and Z2 of the contact surface 110 of the haptic interface 100. Each zone Z1 and Z2, called contact zones or regions, are portions of the contact surface with which the user 101 is in mechanical contact. In the example of FIG. 1, the user 101 is directly in tactile interaction with the haptic interface 100 by touching, by pressing, or by sliding with their fingers on the contact surface.

In alternatives, the user 101 can be in tactile contact with the haptic interface 100 by means of a single finger, several fingers or another part of their body. They can also be in contact with the haptic interface 100 indirectly, via adapted equipment such as a stylus or a touch glove. The rest of the description shall be given for the example of a first and of a second finger of a user, with the understanding that it can be another portion of the body of the user or of an adapted equipment. Likewise the examples given in reference to first and second fingers of a user can be extended to several fingers or contact points of the same user or to a finger or contact point of a first user and a finger or contact point of a second user.

Whether the tactile interaction between the user 101 and the contact surface 110 is a direct contact or an indirect contact, the zone of the contact surface can be a single point or be a set of contiguous or discrete zones such as in the example of FIG. 1.

The actuators 120 act on the contact surface 110 and are configured to apply small movements to said contact surface either in a tangential direction, or in a normal direction, or by a bending moment as explained hereinafter. The actuators 120 are mounted in such a way as to be joined to the thin plate a face of which is the contact surface 110. The actuators 120, at least in the number of two, are positioned at a distance from one another. They can, for example, be positioned diagonally with respect to one another when the contact surface 110 is of rectangular shape or diametrically opposite if the contact surface is circular. When the actuators 120 are in a number greater than two, for example three, four, or more, said actuators are distributed over the periphery of the contact surface 110. In the example of FIG. 2, the actuators are in the number of four and are each positioned in an angle of the contact surface 110. Those skilled in the art will understand that several positions of the actuators can be considered, as long as said actuators are sufficiently separated from one another in order to carry out different movements and deformations of the thin plate.

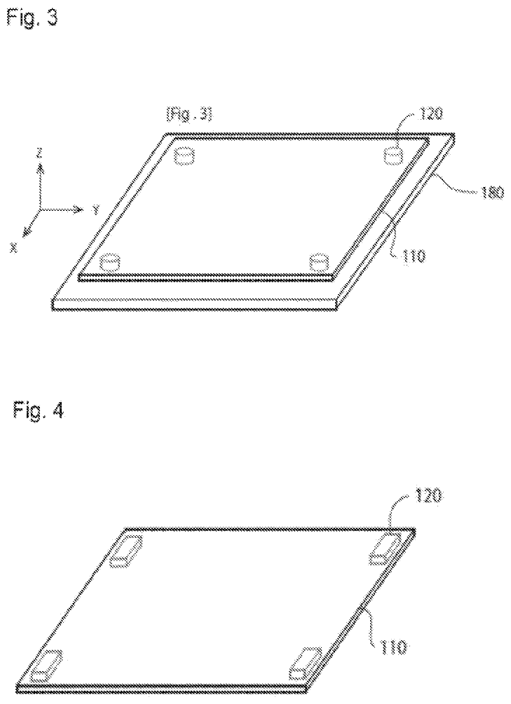

According to certain embodiments, the haptic interface comprises means of visco-elastic suspension configured to allow for small movements, either in the normal direction, or in the tangential direction. The means of suspension are adapted to allow for small movements of the thin plate. These means of visco-elastic suspension can be connected, for example, to a fixed frame 180 shown in FIG. 3. The means of visco-elastic suspension can be, for example, seals made of rubbery material and/or of elastomer, with cells or not, fixed for example by means of a visco-elastic adhesive layer in such a way as to connect the thin plate to the frame of the haptic interface. Often the contact surface is a face of a thin plate linked by adhesion to a framework, open or not, acting as a frame. The contact surface is then capable of procuring haptic sensations thanks to small movements around an average position.

According to certain embodiments, the contact surface 110, or flexible plate, is rigidly embedded in a frame. According to certain other embodiments, the flexible plate is partially embedded in the frame. According to other embodiments, the flexible plate is in a free edge embedding condition.

The processing unit 130 provides the processing of the data received from the device for detecting and for locating and controls the actuators 120. The processing unit implements a method for coordinating actuators, configured to elicit transient or oscillating movements of the contact surface around a neutral state and control a mechanical excitation signal-also called control signal-variable over the course of time, at each actuator 120. The processing unit 130 implements, furthermore, a method for managing interactions so that two different sensations are perceived differently by two users or two fingers of the same hand according to the use that will be permitted. Well-known examples of such uses, from among a very large number, are to modify the enlargement factor of an image or to cause the rotation of a virtual thumbwheel in the plane of the contact surface.

The haptic interface described hereinabove implements a method for generating tactile sensations. This method allows the user to sense tactile sensations at each contact point of the user with the contact surface. In the example of FIG. 1, the method of the invention allows the user 101 to sense haptic sensations in each one of the two fingers in contact with the contact surface, the tactile sensations able to be different in one finger and in the other. In other examples, not shown in the figures, several users can be in contact at the same time with the haptic interface, the haptic interface then being able to provide tactile sensations to each one of the different users even when the latter are at the same time in contact with said haptic interface.

According to the invention, the tactile sensations are generated by the actuators 120 controlled and driven by the processing unit 130. This processing unit 130 implements computer programs for controlling and driving actuators 120 so as to cause movements of the thin plate a face of which is the contact surface. An important case of this driving is when it is desired to cause tactile sensations in one finger without stimulating another finger that is also in contact with the same surface. This other finger will therefore be in interaction with a neutral zone.

The method of the invention has for purpose to generate a movement of the tactile surface procuring the user with a first tactile sensation in a first finger at the instant when their first finger comes into contact with the haptic interface and, at the same time, a second tactile sensation in their second finger at the moment when their second finger comes into contact with the tactile interface, with one of the two able to be neutral or the two sensations able to be different. According to the invention, the tactile surface is the surface of a thin plate that can be moved in a two-way reference system XY or in a three-way reference system XYZ. A three-way reference system means a deformation of the thin plate, as shown in FIGS. 9 to 11. In other words, the method according to the invention proposes, in response to a first contact with the contact surface, to generate a first control signal providing a movement or a deformation of the tactile surface in its totality and, in response to a second contact with the contact surface, to generate a second control signal providing the cancellation or the modification of the movement or of the deformation of the tactile surface at one of the two contact points (i.e. one of the contacts between a finger and the tactile surface).

More precisely, the processing unit 130 implements a method for coordinating actuators 120 configured to take advantage of the principle of linear superimposition of the signals that applies in the case of small movements of solid bodies. This makes it possible in particular to produce at the same time a sensation in a single finger and another sensation in another finger, whether they are transient or persistent, such as described hereinabove.

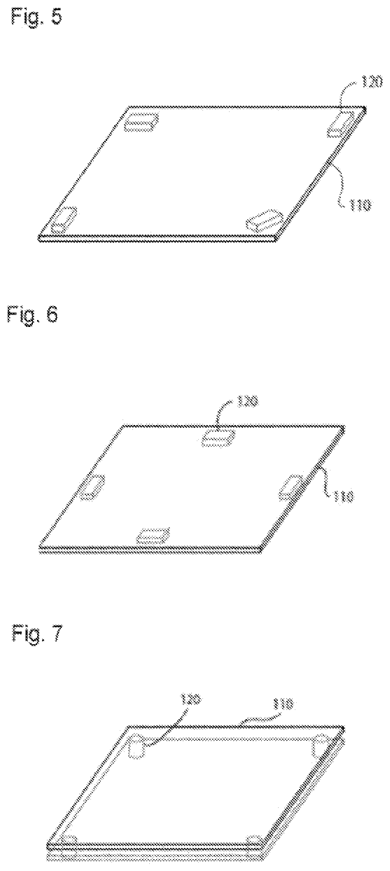

Two examples of touchscreens are shown in FIGS. 3 and 4 with different configurations of actuators 120. In the example of FIG. 3, the actuators 120 apply forces on the thin plate in the direction Z normal to the contact surface 110. In the example of FIG. 4, the actuators 120 apply bending moments on the thin plate around a direction tangent to the contact surface 110. Each actuator 120 is mounted joined to the thin plate, in an angle of surface contact. Such actuators can comprise a magnetic circuit that interacts with one or more coils and can adopt very many configurations: planar, radial, axial, etc. These motors can apply a force on the thin plate by bearing against a base or by acting on a flyweight by application of the principle of the conservation of kinetic momentum. It is also possible to use actuators of the piezoelectric type generally associated with a device for applying movement. As the piezoelectric actuators are rigid, they are adapted to cause bending movements in a thin plate according to monomorphic or bimorphic configurations. The actuators are configured by opposite pairs and are oriented to facilitate the small movements and the small deformations of the thin plate in a large range of frequencies. The intensity of each one of the forces is determined by the processing unit 130 in such a way that the combined action of said forces of the different actuators 120 makes it possible to elicit desired movements that change over the course of time in designated zones of the contact surface. FIGS. 5 and 6 show that actuators can be configured to cause bendings according to different directions and from various locations. In particular, FIG. 5 shows an embodiment where four actuators 120 are positioned in the angles of the contact surface 110 and exert bending forces on the plate in varied directions.

FIG. 6 shows an embodiment where four actuators 120 are positioned near edges of the contact surface, between two angles of said surface-for example midway between two consecutive angles- and exert bending forces on the plate.

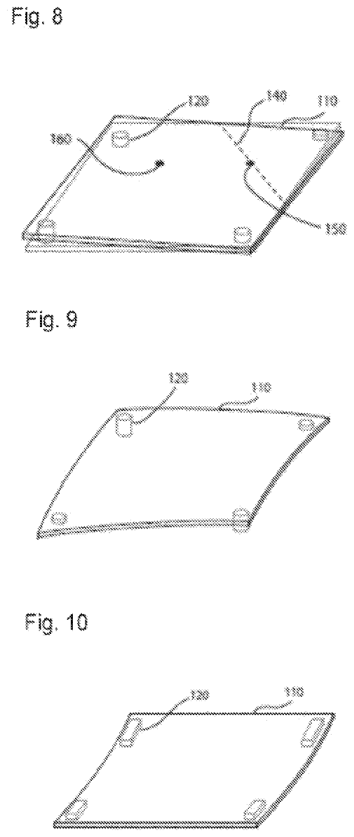

FIG. 7 shows a simple example of such a movement where the four actuators 120, under the effect of four identical controls, move the thin plate in the direction Z normal to the contact surface 110. Quick movements associated with strong accelerations can give rise to inertial forces that are sufficient to cause a deformation of the thin plate and therefore of the contact surface 110 in the form of a convex or concave bulging according to their sign. Those skilled in the art will recognise in this deformation the excitation of a main mode superimposed to a movement of a rigid body such as is described in the structural mechanics treaties. Those skilled in the art will also recognise that the geometry of the modes substantially depends on the embedding conditions of the thin plate that can be simple or complex, giving rise to a very large variety of geometries of deformations. FIG. 8 shows an embodiment similar to that of FIG. 3, but wherein four actuators 120 exert thrusts, in the normal direction Z, able to cause a movement pivoting about an axis of the contact surface is such a way that a finger in contact with this surface, on a line 140, will not receive any tactile signal while a finger in separated contact from this line 140 will receive a signal. FIG. 8 shows how a combination of controls to the four actuators 120 can cause the pivoting of the thin plate about an axis contained in the contact surface, this causing the cancellation of the movements along a line 140. One finger in contact with the location 150 will therefore not be tactily stimulated although a finger in contact with the location 160 will be. As in the example of FIG. 7, substantial accelerations can cause the excitation of modes, which in this case cannot be described simply and which are superimposed to the movement of rigid body. FIGS. 9 and 10 intuitively show how certain combinations of controls of actuators acting in the direction normal to the thin plate, or that apply bending forces to it, can cause quasistatic deformations of this thin plate to which are added simple dynamic deformation modes of higher orders. In particular, FIG. 9 shows an embodiment wherein the four actuators 120 exert thrusts in the normal direction able to cause a bending of the contact surface 110 under the effect of forces. FIG. 10 shows an embodiment wherein the four actuators 120 exert static or dynamic bending forces in the contact surface 110 causing a static or dynamic distortion of this surface.

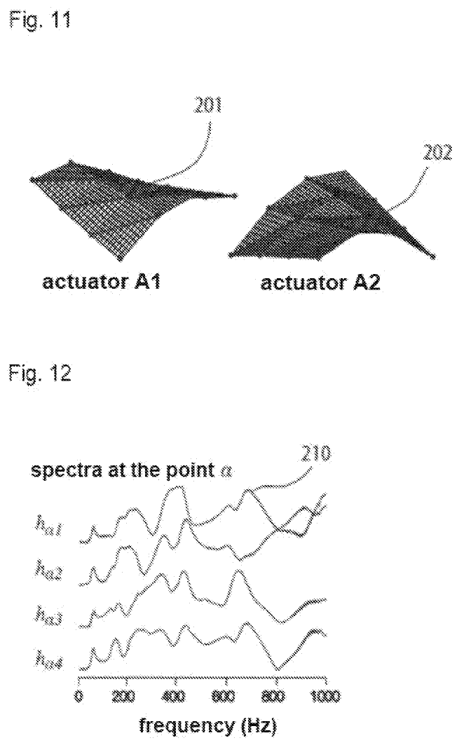

FIG. 11 shows an actual example of the instantaneous deformation of a thin plate able to be used in a haptic interface, in this case free at its periphery, when a first actuator A1 applies a pulse force on it and when a second actuator A2 applies the same pulse effort on it when the two actuators A1 and A2 are separated from one another. If the two pulse forces were applied at the same time, the instantaneous deformation of the thin plate would be the sum of the two instantaneous deformations. Since the movements of all the points of a plate vary over the course of time under the effect of excitations applied at various points of this plate by actuators, it is possible to show these effects in the form of frequency spectra that represent the weighting according to the frequency of the effect of an actuator on any point of the plate. FIG. 12 shows the actual case of a haptic interface where such spectra are represented by curves 210 the vertical deviation of which measures the influence of each one of four actuators on a point α of the contact surface according to the excitation frequency varying from 0 to 1000 Hz. It is therefore possible to represent the behaviour of several regions of the thin plate, designated by an index, i, excited by several actuators designated by an index, j, by a matrix of spectra, Hᵢⱼ, bringing together all the spectra hᵢⱼ characteristic of the association of each zone with each actuator:

Hᵢⱼ=Uᵢ/Sⱼ

where the Uᵢ are the spectra of the movements of the i regions of the thin plate and the Sⱼ are the control signals of the j actuators. Those skilled in the art will recognise that such spectra can be obtained routinely if the region movements of the thin plate are measured, for example, by optical vibrometry, by placing accelerometers in the regions of interest, or by other methods. It is then possible to proceed with identifying spectra by sliding-frequency sinusoidal excitations, by excitation via a white noise, or by the pulse response. It is by a method of this type that FIG. 12 was obtained.

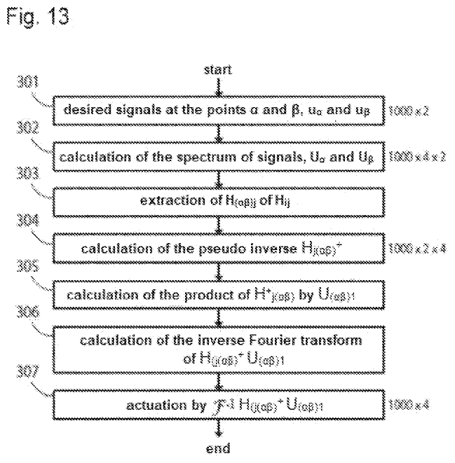

FIG. 13 shows the steps of a method for determining control signals of four actuators making it possible to produce separate desired movements at the same time in two different regions when these regions are known in advance. In the alternative shown in FIG. 13, the method implemented by the haptic interface 100 allows for the management of multiple stimulations. If, for example, the haptic interface detects the presence of a first finger at a location α, the contact surface 110 that has to be stimulated and a second finger is detected at another location 13, that must also be stimulated then the processing unit 130 is able to apply the calculations indicated by FIG. 13.

In FIG. 13, the change in movements u_{α} and u_{β} desired at the locations of the regions α and β are extracted from the memory of the calculating unit 130 or are calculated according to external data in the step 301 and their spectra U_{α} and U_{β} calculated in the step 302. This calculation can be carried out by the fast Fourier transform method also known as discrete Fourier transform (DFT). It must be noted that the step 302 is optional if these signals are known in advance in which case their discrete spectra can be precalculated and memorised by the processing unit 130. The lines H_{αj} and H_{βj} are then extracted in the step 303 of the matrix of the spectra Hᵢⱼ and combined into a sub-matrix H_{(αβ)j}. This matrix of spectra has, for example, four columns and two lines if the haptic interface is provided with four actuators and two locations of regions are selected. Each spectrum contained in the matrix has a length equal to the number of resulting points of the DFT. The step 304 proceeds with the calculation of the pseudo inverse matrix H⁺_{(αβ)j} of the matrix Hon for each frequency at which the spectra are known. This pseudo inverse can be calculated in terms of Moore-Penrose as is well known by those skilled in the art, which in this case minimises the Euclidean norm of the resulting values of their product by a vector. It is also known by those skilled in the art that other pseudo inverse matrices can be calculated in order to optimise other criteria through the minimisation of other norms. In the step 305, the pseudo inverse matrices is multiplied by the matrix with two lines and one column U_{(αβ)1} comprised of spectra U_{α} and U_{β}. In the step 306, the inverse Fourier transform is applied to the matrix product of H⁺H_{j(αβ)} by U_{(αβ)1} so as to synthesise the change over the course of time of the four signals for each one of the four actuators. These changes are applied to the actuators in the step 307 by the processing unit 130. It must also be noted that the steps 303, 304, 305 and 306 are optional if the data is known in advance; in this case, the results of each step can be precalculated and memorised by the processing unit 130.

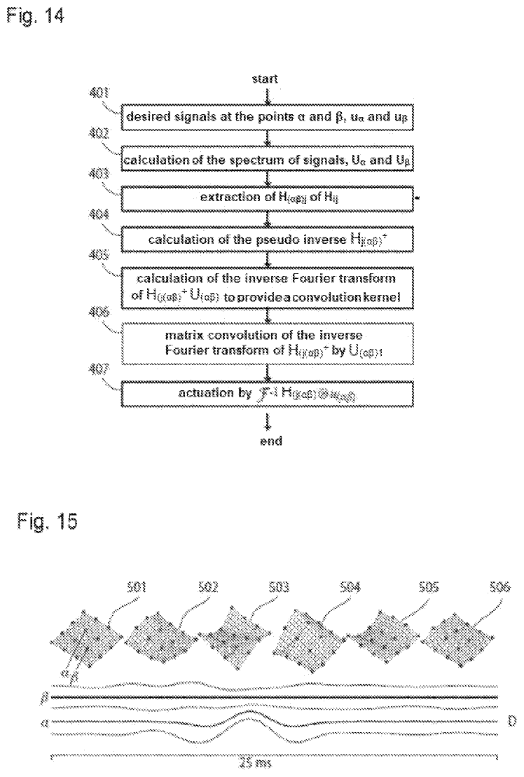

FIG. 14 shows the steps of a method for determining control signals of four actuators making it possible to produce desired separate movements at the same time in two different regions when the location of these regions vary over the course of time. In particular, FIG. 14 shows a chain of calculations or of pre-calculations similar to that of FIG. 13 with steps 401, 402, 403 and 404 identical to the steps 301, 302, 303 and 304 of FIG. 13. In the alternative of FIG. 14, the steps 405 and 406 are carried out in the time domain rather than in the Fourier domain. This chain of calculations and of pre-calculations is suitable in the case where the locations α and β are not known in advance and where the time change of the signals has to be updated in real time. In such a case, the vectors coming from the step 405 are called convolution kernels, h⁺ₐⱼ and h⁺_{βj}, forming a kernel From, which can be calculated in real time or precalculated.

FIG. 15 shows the result of the application of the treatment chains of FIGS. 13 and 14. It shows how a weighting over the course of time of the dynamic distortions caused by the four actuators excited by specific waveforms can reconstruct desired movements D to the extent that, at a desired point α, a desired waveform (here, a Ricker wavelet), while, at the same time, another desired point β remains immobile. Other points of the surface are free to be moved without affecting the tactile operation of the haptic interface. In particular, the movements of a thin plate deformed by the action of four actuators are mounted at the instants 501, 502, 503, 504, 505 and 506 and where the locations α and β are indicated. In this particular case, it is desired that the movement of the location α changes according to a Ricker wavelet also known as Mexican hat while the location β remains immobile. The time changes over a period of 25 ms are indicated in the lower portion of FIG. 15 where the time trajectories of the regions in the vicinity of the locations α and β can be seen. The calculations for implementing the method were shown for the case of an arbitrary number of actuators determining the time change of the movements of two separate regions, however it will be easy for those skilled in the art to extend this method to a larger number of regions of a contact surface of which on wishes to determine the trajectories independently and at the same time.

Although described through a certain number of examples, alternatives and embodiments, the method for generating tactile sensations of the invention and the haptic interface implementing this method comprises various alternatives, modifications and improvements that shall appear as obvious to those skilled in the art, with the understanding that these alternatives, modifications and improvements are part of the scope of the invention.

1. A method for generating a tactile sensation intended to be sensed by a user in contact with a contact surface of a haptic interface, comprising an operation of simultaneously emitting a first control signal for controlling a first actuator and a second control signal for controlling a second actuator, at the same time as the first actuator, the first and second actuators being joined to the contact surface and bringing about movements of said contact surface, wherein:
the first control signal comprises a first time change providing to a first region of the contact surface a first time change, and providing a second time change to a second region of the contact surface, and
the second control signal comprises a second time change providing to the first region of the contact surface a second time change, and providing a second time change to the second region of the contact surface,
where the first control signal and the second control signal are such that the time change of the first region of the contact surface is described by a desired function of the time separate from another desired function of the time describing the time change of the second region of the contact surface.

2. The method according to claim 1, further comprising one or more additional actuators comprising an operation of simultaneously emitting one or more additional control signals for controlling one or more additional actuators at the same time as the first actuator and second actuator, the one or more additional actuators being joined to the contact surface and bringing about movements of said contact surface, and wherein:
the one or more additional control signals each comprise additional time changes providing to a first region of the contact surface and to a second first region of the contact surface additional time changes.

3. The method according to claim 1, further comprising one or more additional contact regions receiving additional time changes coming from additional actuators and wherein a total number of actuators is greater than or equal to a total number of regions.

4. The method according to claim 1, further comprising a weighted combination of a first dynamic distortion, generated by the first actuator under the effect of the first control signal, and of a second dynamic distortion generated by the second actuator under the effect of the second control signal.

5. The method according to claim 2, further comprising a weighted combination of a first dynamic distortion, generated by the first actuator under the effect of the first control signal, of a second dynamic distortion generated by the second actuator under the effect of the second control signal, and of one or more additional dynamic distortions generated by one or more additional actuators under the effect of one or more additional control signals.

6. The method according to claim 1, wherein when the first region and the second region are known in advance the first control signals and the second control signals are determined by the following operations:
a) identifying, for each one of the actuators and each one of the regions of the contact surface, a frequency spectrum representing the weighting according to the frequency of the effect of the actuator over any region of the contact surface;
b) calculating an inverse matrix H⁻¹₂₂ of matrix of spectra H₂₂ associating the first region and the second region, with the first actuator and with the second actuator;
c) multiplying the inverse matrix H¹₂₂ by the matrix U₂1 obtained by stacking the frequency spectra U₁ and U₂ coming from the transformation from the time domain to the frequency domain of the desired movements, of the contact surface in the first and second regions;
d) transforming in the time domain of the products obtained in the step c);
e) applying to the actuators.

7. The method according to claim 2, wherein when the first region and the second region are known in advance, the first control signals, the second control signals and the possible additional signals are determined by the following operations:
f) identifying, for each one of the actuators and each one of the regions of the contact surface, a frequency spectrum representing the weighting according to the frequency of the effect of the actuator over any region of the contact surface;
g) extracting lines corresponding to regions α and β coming from matrix of the spectra Hᵢⱼ associating each region with each actuator and stacking said lines corresponding to the regions α and β in a single matrix H_{(αβ)j};
h) calculating the pseudo inverse matrix H⁺_{(j(αβ)} of H_{(αβ)j};
i) multiplying the pseudo inverse matrix H⁺_{(j(αβ)} by the matrix U_{(αβ)1} obtained by stacking the frequency spectra U_{α}, and U_{β} coming from the transformation from the time domain to the frequency domain of the desired movements, u_{α}, and u_{β}, of the contact surface in the regions α and β.
j) transforming in the time domain of the products obtained in the step i);
k) applying to the actuators.

8. The method according to claim 2, wherein, when the first region, the second region and the possible additional regions are known in advance, the first control signals, the second control signals and the possible additional signals are determined by the following operations:
l) identifying, for each one of the actuators and each one of the regions of the contact surface, a frequency spectrum representing the weighting according to the frequency of the effect of the actuator over any region of the contact surface;
m) extracting lines corresponding to regions α and β and additional regions issue of the matrix of the spectra Hᵢⱼ associating each region with each actuator and stacking said lines corresponding to the regions α and β and to the additional regions into a single matrix H_{cj};
n) calculating the pseudo inverse matrix H⁺_{jc} of H_{cj};
o) multiplying the pseudo inverse matrix H⁺_{jc} by the matrix U_{cl} obtained by stacking the frequency spectra coming from the transformation of the desired movements, u_{α}, and u_{β}, of the contact surface in the regions α and β and of the additional desired movements.
p) transforming in the time domain of the products obtained in the step o);
q) applying to the actuators.

9. The method according to claim 1, wherein when the first or the second region vary over the course of time, the first control signals, the second control signals are determined by the following operations:
r) identifying, for each one of the actuators and each one of the regions of the contact surface, a frequency spectrum representing the weighting according to the frequency of the effect of the actuator over any region of the contact surface;
s) calculating the inverse matrix H⁻¹₂₂ of the matrix of the spectra H₂₂ associating the first region and the second region, with the first actuator and with the second actuator;
t) transforming in the time domain of the products obtained in the step s);
u) matrix convolving of the product of the step t) by the stack of the desired movements.
v) applying to the actuators.

10. The method according to claim 2, wherein when the first region or the second region vary over the course of time, the first control signals, the second control signals and the possible additional control signals are determined by the following operations:
w) identifying, for each one of the actuators and each one of the regions of the contact surface, a frequency spectrum representing the weighting according to the frequency of the effect of the actuator over any region of the contact surface;
x) extracting of the lines corresponding to the regions α and β coming from the matrix of the spectra Hᵢⱼ associating each region with each actuator and stacking said lines corresponding to the regions α and β in a single matrix H⁺_{(αβ)j};
y) calculating the pseudo inverse matrix H⁺_{j(αβ)} of H⁺_{(αβ)j};
z) transforming in the time domain of the products obtained in the step y);
aa) matrix convolving of the product of the step z) by the stack of the desired movements;
bb) applying to the actuators.

11. The method according to claim 2, wherein, when the first region or the second region, or the possible additional regions vary over the course of time, the first control signals, the second control signals and the possible additional control signals are determined by the following operations:
cc) identifying, for each one of the actuators and each one of the regions of the contact surface, a frequency spectrum representing the weighting according to the frequency of the effect of the actuator over any region of the contact surface;
dd) extracting lines corresponding to regions α and β and additional regions issue of the matrix of the spectra Hᵢⱼ associating each region with each actuator and stacking said lines corresponding to the regions α and β and to the additional regions into a single matrix H_{cj};
ee) calculating the pseudo inverse matrix H⁺_{jc} of H_{cj};
ff) transforming in the time domain of the products obtained in the step ee);
gg) matrix convolving of the product of the step ff) by the stack of the desired movements;
hh) applying to the actuators.

12. A haptic interface implementing the method according to claim 1, comprising:
a contact surface provided with a device for detecting and locating at least one contact point between at least one user and said contact surface;
at least two actuators being joined to a rigid portion, mounted at a distance from one another and adapted to be actuated at the same time so as to generate at least one movement of said rigid portion; and
a processing unit adapted to control each actuator with a different time change.

13. The haptic interface according to claim 12, further comprising a frame wherein the contact surface is mounted.

14. The haptic interface according to claim 13, wherein the contact surface is connected to the frame via means of visco-elastic suspension.

15. The haptic interface according to claim 12, wherein the contact surface is rigidly embedded over its entire periphery on a frame.

16. The haptic interface according to claim 12, wherein the contact surface is partially embedded on a frame.

17. The haptic interface according to claim 12, wherein the contact surface is in a free edge embedding condition.

18. An interactive electronic device, comprising a haptic interface according to claim 12.
